(19) United States
(12) Patent Application Publication
(10) Pub. No.: US 2026/0023449 A1
(43) Pub. Date: Jan. 22, 2026

(54) TOUCH DISPLAY DEVICE CONTROL METHOD AND TOUCH DISPLAY DEVICE

(71) Applicant: MEDIATEK INC., Hsinchu City (TW)

(72) Inventors: Yi-Hsin Shen, Hsinchu City (TW); Nien-Hsien Lin, Hsinchu City (TW); Chiu-Jen Lin, Hsinchu City (TW); Cheng-Che Chen, Hsinchu City (TW)

(73) Assignee: MEDIATEK INC., Hsinchu City (TW)

(21) Appl. No.: 19/270,526

(22) Filed: Jul. 16, 2025

Related U.S. Application Data
(60) Provisional application No. 63/672,277, filed on Jul. 17, 2024.

(51) Int. Cl. G06F 3/041; G06F 3/042; G06F 3/044; H04M 1/72403

(52) U.S. Cl. CPC G06F 3/04166; H04M 1/72403; G06F 3/042; G06F 3/044; H04M 2250/22

(57) ABSTRACT

A touch display device control method, applied to a touch display device installed with an application and comprising a touch sensor, comprising: (a) receiving a first input event from the touch sensor, by an operating system of the touch display device; and (b) the operating system delivering the first input event or a predicted input event to the application before and responding to a start operation of a first frame generation required by the application. A touch display device which uses the touch display device control method is also disclosed.

### CROSS REFERENCE TO RELATED APPLICATIONS

This application claims the benefit of U.S. Provisional Application No. 63/672,277, filed on Jul. 17, 2024. The content of the application is incorporated herein by reference.

### BACKGROUND

In related art, a touch report rate of a touch display device (e.g., a mobile phone) is getting higher to monitor frequently users' touch movement. However, the OS (operating system) doesn't deliver those input events to the application immediately. Instead, it is triggered by a Vsync signal, which is a signal limited by the clock of a display refresh rate of the touch display device. Also, the application may provide various frame rates to provide different user experience while users can choose different graphic qualities as well. As a result, a frame rate cannot always synchronize with the Vsync signal.

In some techniques, an application may retrieve input events directly from the touch sensor which senses the input invents. However, in such case, the application would be always woken up and interrupted by each input event, causing more power consumption.

Therefore, a new method is needed to solve these problems.

### SUMMARY

One objective of the present application is to provide a touch display device control method which can provide a better synchronization of the input event reception of the application and the frame generation.

Another objective of the present application is to provide a touch display device which can provide a better synchronization of the input event reception of the application and the frame generation.

One embodiment of the present invention is to provide a touch display device control method, applied to a touch display device installed with an application and comprising a touch sensor, comprising: (a) receiving a first input event from the touch sensor, by an operating system of the touch display device; and (b) the operating system delivering the first input event or a predicted input event to the application before and responding to a start operation of a first frame generation required by the application.

Another embodiment of the present invention is to provide a touch display device, installed with an operating system, comprising: a touch sensor; a storage device, installed with an application: a processing circuit, configured to execute at least one program to perform a touch display device control method comprising: (a) receiving a first input event from the touch sensor, by the operating system; and (b) the operating system delivering the first input event or a predicted input event to the application before and responding to a start operation of a first frame generation required by the application.

In view of above-mentioned embodiments, the input event detected by the touch sensor can be delivered to the application corresponding to the start operation of frame generation. By this way, the input event reception of the application and the frame generation can be more synchronized. Further, user's touch feedback experience can be improved.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a touch display device control method, according to one embodiment of the present invention.

FIG. 2, FIG. 3 and FIG. 4 are schematic diagrams illustrating detail steps of “start operation” in FIG. 1, according to different embodiments of the present invention.

FIG. 5 is a block diagram illustrating a touch display device, according to one embodiment of the present invention.

FIG. 6 is a flow chart illustrating a touch display device control method, according to one embodiment of the present invention.

### DETAILED DESCRIPTION

In the following descriptions, several embodiments are provided to explain the concept of the present application. The term “first”, “second”, “third” in following descriptions are only for the purpose of distinguishing different one elements, and do not mean the sequence of the elements. For example, a first device and a second device only mean these devices can have the same structure but are different devices.

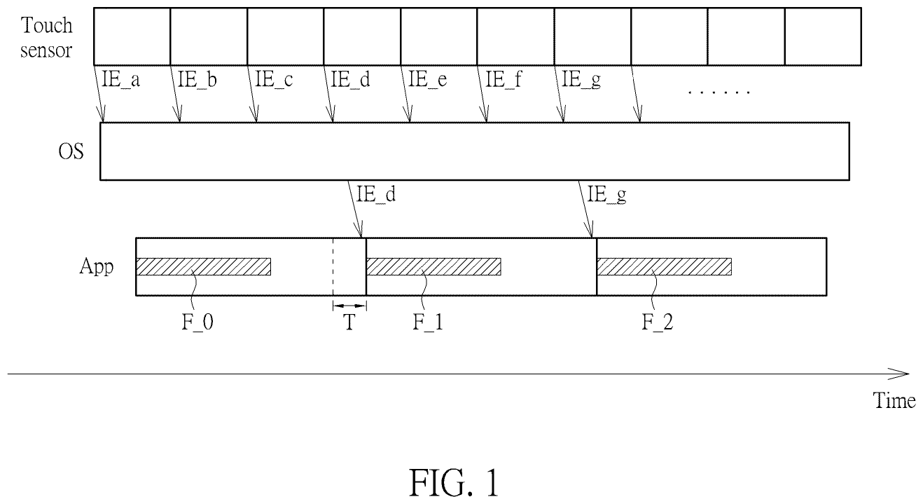

FIG. 1 is a schematic diagram illustrating a touch display device control method, according to one embodiment of the present invention. In FIG. 1, the touch sensor continuously reports input events IE_a, IE_b, IE_c . . . to the OS. In one embodiment, the touch sensor periodically reports input events IE_a, IE_b, IE_c . . . to the OS. The input event IE_a, IE_b, IE_c . . . may represent that whether an object (e.g., a finger or a stylus) touches the touch display device or not. The touch sensor may be various kinds of touch sensor. For example, the touch sensor may be a capacitive touch sensor or an optical touch sensor.

The OS delivers a first input event among the received input events to the application before and responding to a start operation of a first frame generation required by the application. Please note, the first input event mentioned here only represents one of the received input events rather than the input event which is firstly received. The start operation means the first frame generation is initiated to be performed. The first frame generation is for generating a first frame F_1. In one embodiment, the first input event is an input event closest to the start operation of the first frame generation among all input events received by the OS before the start operation of the first frame generation. For example, in the embodiment of FIG. 1, the OS receives the input events IE_a, IE_b, IE_c and IE_d before the start operation of the first frame generation. In such case, the first input event is the input event IE_d.

In one embodiment, the OS delivers the first input event to the application in a predetermined time interval (e.g., the predetermined time interval T) before the start operation, to ensure that the input event is received by the application before the start operation. In another embodiment, the OS does not deliver any other input event in a time interval during the start operation of the first frame generation and a start operation of a second frame generation required by the application. The first frame generation is for generating the first frame F_1 and the second frame generation is for generating a second frame F_2 following the first frame F_1. In such case, the OS may also deliver a second input event (e.g., the input event IE_g) to the application before and responding to the start operation of the second frame generation. In one embodiment, the second input event is an input event closest to the start operation of the second frame generation among all input events received by the OS before the start operation of the second frame generation.

In view of the above-mentioned embodiments, the OS delivers the input event to the application responding to the start operation rather than according to a Vsync signal of the touch display device.

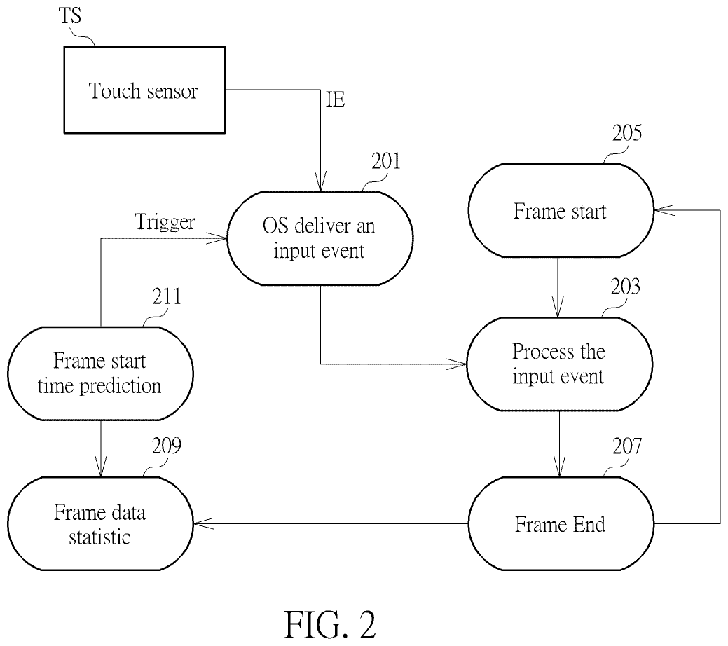

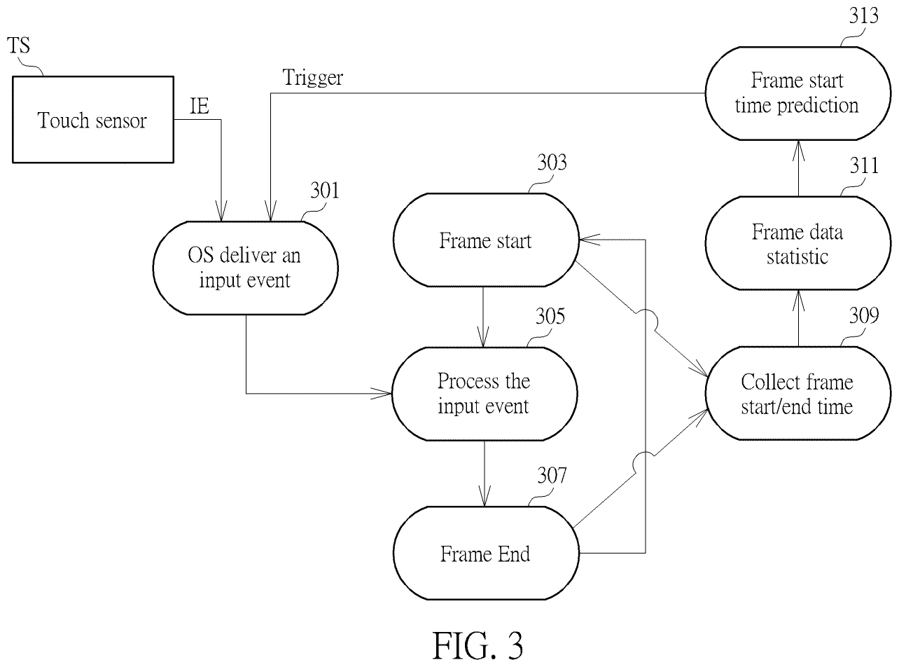

Information of the start operation can be acquired by various methods. In one embodiment, a start time of the first frame generation is predicted, and the OS delivers the first input event to the application before and responding to the start time. FIG. 2 is a schematic diagram illustrating detail steps of “start operation” in FIG. 1, according to different embodiments of the present invention. Specifically, FIG. 2 illustrates detail steps of “acquiring start time of frame generation”. As shown in FIG. 2, the touch sensor TS provides input events IE. The step 201 delivers the input event according to a frame start time (i.e., a start time of frame generation) predicted in the step 211. Also, steps 203, 205 and 207 mean the input event delivered by the OS is processed by the application during the start time of the frame generation and the end of the frame generation. Additionally, the steps 209 and 211 mean the frame start time may be predicted according to the frame data statistic in the step 209.

Various methods can be applied to compute the start time. For example, in the U.S. application Ser. No. “19/245,436”, methods of acquiring the start time of frame generations are disclosed. However, the scope of the present application is not limited to these methods. In one embodiment, the start time may be computed based on historical frame data indicating at least one of previous frame rate, previous frame start time and previous frame duration.

Besides predicting the start time of frame generation, the start time of frame generation may also be acquired by other methods. In one embodiment, the OS receives a start time of the frame generation from the application. FIG. 3 is a schematic diagram illustrating detail steps of “start operation” in FIG. 1, according to different embodiments of the present invention. Specifically, FIG. 3 illustrates detail steps of “acquiring start time of frame generation”.

As shown in FIG. 3, the touch sensor TS provides input events IE. In the step 301, the OS delivers the input event according to a frame start time predicted in the step 313. Also, steps 303, 305 and 307 mean the input event delivered by the OS is processed by the application during the start time of the frame generation and the end of the frame generation. The step 309 collects the frame start time and the frame end time (i.e., the end time of the frame generation), for example, from the application via SDK (Software Development Kit) or API (Application Programming Interface). Additionally, the steps 311 and 313 mean the start time of the frame generation may be predicted according to the frame data statistic in the step 311. Please note, in the embodiment of FIG. 3, since the step 311 receives the frame start time and the frame end time collected in the step 309. The step 313 may be regarded as: acquiring the start time provided by the application.

In another embodiment, the application generates a notification for informing the OS to deliver the input event to the application, when the start operation is about to start. FIG. 4 is a schematic diagram illustrating detail steps of “start operation” in FIG. 1, according to different embodiments of the present invention. Specifically, FIG. 4 illustrates detail steps of “acquiring start time of frame generation”.

As shown in FIG. 4, the touch sensor TS provides input events IE. In the step 401, the OS delivers the input event according to a notification from the step 403. Also, steps 403, 405 and 407 mean the input event delivered by the OS is processed during the start time of the frame generation and the end of the frame generation. In the embodiment of FIG. 4, in the step 403, the application further generates a notification for informing the OS to deliver the input events to the application, when the start operation is about to start. The description of “the start operation is about to start” may represent the application generates the notification in a predetermined time before the start time. Alternatively, the description of “the start operation is about to start” may represent the application generates the notification according to a tag, a symbol, or a code which represents the frame generation is to be started. It will be appreciated that the description of “the start operation is about to start” is not limited to these examples.

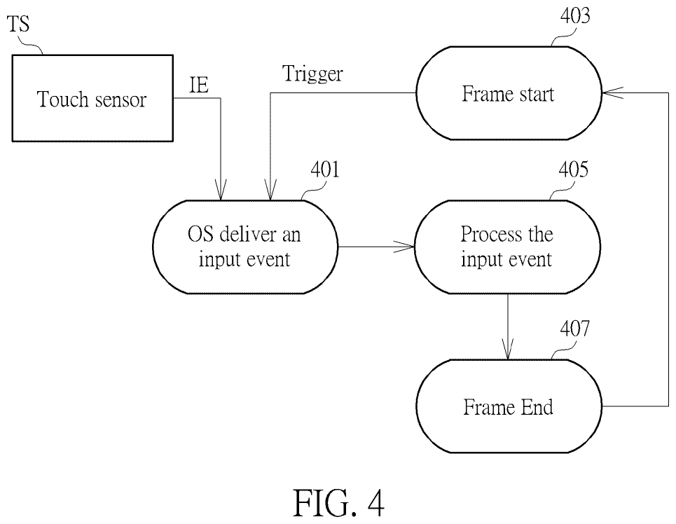

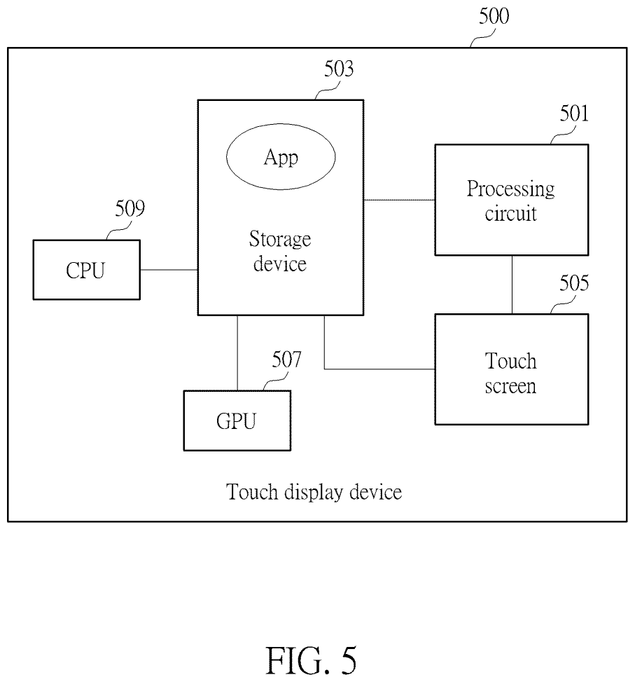

FIG. 5 is a block diagram illustrating a touch display device 500, according to one embodiment of the present invention. Please note, the above-mentioned embodiments can be implemented by other devices rather than limited to the touch display device 500. The touch display device 500 can be any device which can display frames, such as a mobile phone or a tablet computer. As shown in FIG. 5, the touch display device 500 comprises a processing circuit 501, a storage device 503 and a touch screen 505. The touch screen may comprise the above-mentioned touch sensor.

The above-mentioned application is installed to the storage device 503. The application can also be installed to a storage device which is different from the storage device 503. Also, the storage device 503 may store at least one program, and the processing circuit 501 executes the program to perform the above-mentioned embodiments. The above-mentioned OS may also be installed in the storage device 503 or installed in another storage device.

Additionally, the touch display device 500 may comprises at least one graphic component which is used to generate frames according to the requirement from the application, such as the GPU 507 or the CPU 509. In other words, the GPU 507 and the CPU 509 performs the above-mentioned frame generation. In one embodiment, the processing circuit 501 is integrated to the CPU 509.

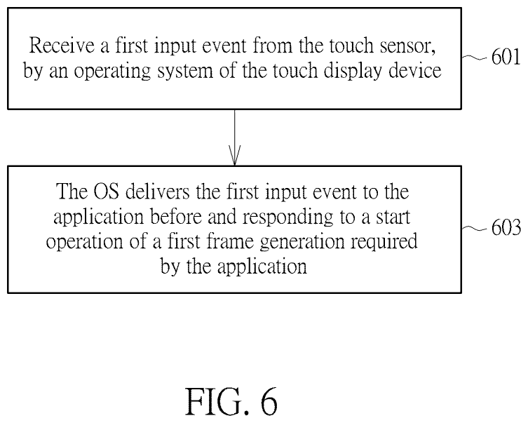

FIG. 6 is a flow chart illustrating a touch display device control method, according to one embodiment of the present invention. The touch display device control method is applied to a touch display device (e.g., the touch display device in FIG. 5) installed with an application and comprising a touch sensor.

The flow chart in FIG. 6 comprises following steps

### Step 601

Receive a first input event from the touch sensor, by an OS of the touch display device.

### Step 603

The OS delivers the first input event to the application before and responding to a start operation of a first frame generation required by the application.

As above-mentioned, in one embodiment, the OS does not deliver the first event to the application according to a Vsync signal of the touch display device. Also, in one embodiment, the first input event is an input event closest to the start operation among all input events received by the operating system.

Also, the OS may deliver the first input event to the application according to a start time of frame generation.

In the step 603 the OS may deliver a predicted input event to the application rather than the first input event. For more detail, the OS may compute an predicted coordinate of the predicted input event according to all input events received by the OS, and then transmit the anticipated input event to the application. For example, in the embodiment of FIG. 1, the OS can deliver the anticipated input event computed according to the input events IE_a, IE_b, IE_c, IE_d rather than the input event IE_d. By this way, a smooth touch movement result can be acquired. For example, when the object such as a finger is accelerating, decelerating, or moving in a curved trajectory, more input events can be acquired thus can help predict the next position of the object. Please note the term “all input events” mentioned here can mean the input events received by the OS in a predetermined time period. In view of above-mentioned embodiments, the input event detected by the touch sensor can be delivered to the application corresponding to the start operation of frame generation. By this way, the input event reception of the application and the frame generation can be more synchronized. Further, user's touch feedback experience can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch display device control method, applied to a touch display device installed with an application and comprising a touch sensor, comprising:
(a) receiving a first input event from the touch sensor, by an operating system of the touch display device; and
(b) the operating system delivering the first input event or a predicted input event to the application before and responding to a start operation of a first frame generation required by the application.

2. The touch display device control method of claim 1, wherein the operating system delivers the first input event to the application in a predetermined time interval before the start operation.

3. The touch display device control method of claim 1, wherein the operating system does not deliver any other input event in a time interval during the start operation of the first frame generation and a start operation of a second frame generation required by the application, wherein the first frame generation is for generating a first frame and the second frame generation is for generating a second frame following the first frame.

4. The touch display device control method of claim 3, further comprising:
the operating system delivering a second input event to the application before and responding to the start operation of the second frame generation required by the application.

5. The touch display device control method of claim 1, wherein the operating system does not deliver the first event to the application according to a Vsync signal of the touch display device.

6. The touch display device control method of claim 1, wherein the first input event is an input event closest to the start operation among all input events received by the operating system.

7. The touch display device control method of claim 1, wherein the step (b) predicts a start time of the first frame generation based on historical frame data indicating at least one of previous frame rate, previous frame start time and previous frame duration, and the operating system delivers the first input event to the application before and responding to the start time.

8. The touch display device control method of claim 1, wherein the step (b) receives a start time of the first frame generation from the application, and the operating system delivers the first input event to the application before and responding to the start time.

9. The touch display device control method of claim 1, wherein the application generates a notification for informing the operating system to deliver the first input event to the application, when the start operation is about to start.

10. A touch display device, installed with an operating system, comprising:
a touch sensor;
a storage device, installed with an application:
a processing circuit, configured to execute at least one program to perform a touch display device control method comprising:
(a) receiving a first input event from the touch sensor, by the operating system; and
(b) the operating system delivering the first input event or a predicted input event to the application before and responding to a start operation of a first frame generation required by the application.

11. The touch display device of claim 10, wherein the operating system delivers the first input event to the application in a predetermined time interval before the start operation.

12. The touch display device of claim 10, wherein the operating system does not deliver any other input event in a time interval during the start operation of the first frame generation and a start operation of a second frame generation required by the application, wherein the first frame generation is for generating a first frame and the second frame generation is for generating a second frame following the first frame.

13. The touch display device of claim 12, wherein the touch display device control method further comprises:
the operating system delivering a second input event to the application before and responding to the start operation of the second frame generation required by the application.

14. The touch display device of claim 10, wherein the operating system does not deliver the first event to the application according to a Vsync signal of the touch display device.

15. The touch display device of claim 10, wherein the first input event is an input event closest to the start operation among all input events received by the operating system.

16. The touch display device of claim 10, wherein the step (b) predicts a start time of the first frame generation based on historical frame data indicating at least one of previous frame rate, previous frame start time and previous frame duration, and the operating system delivers the first input event to the application before and responding to the start time.

17. The touch display device control method of claim 10, wherein the step (b) receives a start time of the first frame generation from the application, and the operating system delivers the first input event to the application before and responding to the start time.

18. The touch display device control method of claim 10, wherein the application generates a notification for informing the operating system to deliver the first input event to the application, when the start operation is about to start.
